(19) United States
(12) Patent Application Publication
(10) Pub. No.: US 2022/0053778 A1
(43) Pub. Date: Feb. 24, 2022

(54) DOUGH SPREADING ROLLER

(71) Applicant: GOTHIA HOLDINGS INC., Barrie (CA)

(72) Inventors: Mohammadreza SHABANZADE, Barrie (CA); Birger Emst SVENNINGSON, Barrie (CA)

(21) Appl. No.: 17/275,650

(22) PCT Filed: Sep. 14, 2018
(86) PCT No.: PCT/CA2018/000171

§ 371 Date: Mar. 11, 2021

(51) Int. Cl. A21C 1/08; A21C 3/02; A21D 6/00

(52) U.S. Cl. CPC A21C 1/083; A21D 6/00; A21C 3/021

(57) ABSTRACT

The present invention relates to a roller to be used as part of an apparatus for spreading and flattening dough, in the context of an industrial bread making line. The dough spreading roller of the present invention is comprised of multiple offset discs installed on a shaft, which accords the roller with an undulating surface. The dough spreading roller of the invention provides a massaging and kneading force to the dough from underneath the conveyor belt. The dough spreading roller also includes end nuts which serve to level the edges of the conveyor belt level during use. The conveyor belt is also provided with a calendar roller located above which provides an opposing and flattening force to said dough spreading roller. The dough is therefore processed between the calendar roller, conveyor, and underlying spreading roller. The invented configuration provides a gentler, less vigorous treatment of the dough which facilitates industrial manufacture of a softer, less processed dough.

### FIELD OF THE INVENTION

The present invention relates to a roller to be used as part of an apparatus for spreading and flattening dough, in the context of an industrial bread making line.

In the typical large-scale manufacture of flatbread, the dough is processed into a continuous stream which is then further pressed and flattened between a series of rollers and conveyor belts. This relatively strenuous treatment, when used with many recipes for flatbreads, can result in overworked, dense dough which ultimately produces an inferior product.

The dough spreading roller of the present invention provides a much gentler treatment to spread and facilitate flattening of the dough stream, by providing a massaging and kneading force from underneath the conveyor belt. This eliminates the need for steps involving harsh pressing and flattening of the dough, and results in a softer, more flexible dough that produces a superior finished bread.

### BACKGROUND OF THE INVENTION

Industrial bread making lines typically involve the formation of a stream of dough that is then processed along conveyor belts between multiple sets of rollers before it is cut, shaped, and baked. Such typical dough processing machinery has been adequate for many types of bread. However, when used to make flatbreads such as naan, chapatis, and pizza crusts, it has been frequently found that the dough processed by such machinery becomes overprocessed and tough. This is because such doughs often use high-gluten flours, and are therefore more susceptible to problems caused by over handling.

Prior art devices typically work the dough by rolling and flattening the dough stream between hard, nonyielding surfaces such as between opposing calendar rollers or between a roller and a firm conveyor line. What is needed is a way in which a stream of dough formed in the context of an industrial bread making operation can be flattened to a desired height and width in a gentler way, by subjecting the dough to a less vigorous treatment.

### SUMMARY OF THE INVENTION

The general object of the present invention is to provide a dough flattening apparatus provided with a dough spreading roller that places less pressure and stress on the dough, as part of an industrial dough-making line.

In one aspect, the invention relates to a dough spreading roller which is comprised of multiple discs installed closely together on a shaft. Each individual disc includes an outer ring which incorporates ball bearings, installed around an inner core with an off-centre passage. The passage of the inner core is provided with multiple keyed grooves which can mate with a corresponding ridge provided along the shaft. The discs are installed on the shaft such that after installing a first disc, the next disc is turned by a distance corresponding to one groove relative to the prior disc, and then installed. This pattern continues as further discs are installed.

The individual discs for a given roller are identical to each other, and their inner cores are therefore off-centre by the same amount. Therefore, as the roller is constructed using individual rings, what results is an outer surface for the roller that incorporates a spiral waveform pattern of varying depth.

In a further aspect, the discs may be installed on the shaft of the dough spreading roller to provide a mirror image spiralling pattern across the surface of the roller, extending from the centre of the roller. This can be accomplished by first installing a disc in the middle of the shaft, and then installing adjacent discs on either side of the first disc in the manner described above, but ensuring that the respective discs are oriented in the same direction on either side of the first disc so as to create a mirror image with a centre at the midpoint of the shaft. This configuration results in the dough stream being gently and evenly pressed from its centre towards its outer edges.

In a further aspect, the dough spreading roller is installed directly underneath a conveyor belt in an industrial dough making machine, such that it is in physical contact with the conveyor belt. As the dough stream passes over the conveyor, it does not directly touch the dough spreading roller. Rather, the dough spreading roller rotates under the conveyor to gently press the dough, which comes into indirect contact through the conveyor belt with the raised and indented portions of the waveform pattern on the surface of the dough spreading roller. This provides the dough with a gentle and indirect kneading pressure from underneath the conveyor.

In a still further aspect, the dough spreading roller is used in cooperation with a calendar roller provided above the conveyor belt. The calendar roller directly contacts the dough stream, which becomes pressed between the calendar roller and the conveyor belt, and is also subjected to the kneading pressure from underneath the conveyor belt provided by the dough spreading roller. In this manner the dough is gently flattened between the calendar roller and the conveyor. Due to the configuration of the conveyor and accompanying dough spreading roller, the conveyor surface is provided with a certain amount of yield due to the varying waveform surface of the dough spreading roller. Therefore, the dough does not become overly pressed and processed between two hard opposing surfaces as occurs in prior art configurations.

In a further aspect, the dough spreading roller is also provided with additional wave-suppressing nuts that are installed at the ends of the roller surface. The wave-suppressing nuts function to hold up the sides of the conveyor belt so that it does not overly sag on the sides due to the movement of the waveform surface of the dough spreading roller under the conveyor. The wave-suppressing nuts are installed opposite in phase to the next adjacent discs which form part of the waveform surface. In other words, where the adjacent disc has been installed to form an indented part of the waveform, the corresponding wave-suppressing nut is installed on the end of the roller so that it compensates for the indentation by providing a higher surface that is approximately level with the highest point of the waveform. In this way the conveyor belt is maintained at a uniform level across the length of the dough spreading roller, and is less subject to wear and vibration due to the undulating movements of the dough spreading roller as it rotates beneath.

In a further aspect, the calendar roller is provided with a mechanism to set its distance from the conveyor belt surface, so that the thickness of the dough stream can be set. Also provided is a pulley system on which the conveyor belt is arranged so as to avoid unnecessary contact and interference with the rotating dough spreading roller.

A method of constructing and using the dough spreading roller of the present invention is also provided. The dough spreading roller can be readily customised to provide the desired amount of kneading pressure on the dough stream, by configuring and providing discs which can form deeper or shallower indented portions on the dough spreading roller. Depending on the recipe being prepared, the user may change out the roller and replace the discs, or replace the inner cores of the discs, with those appropriate for the amount of kneading required for the desired product. The user may then operate the roller by installing it in the conveyor line, calibrating the calendar roller so that a desired target thickness for the dough stream is set, and setting the conveyor and rollers to rotate.

The dough spreading roller of the invention provides a means by which a gentle and indirect kneading action on a dough stream can take place, which effectively flattens the dough as required but reduces the amount of processing and handling of the dough. This advantageously results in a higher quality dough, which ultimately produces better quality bread.

### BRIEF DESCRIPTION OF THE DRAWINGS

The present invention will now be better understood with reference to the description and to the accompanying drawings in which:

FIG. 1 is a side view of the dough spreading roller incorporated in a conveyor line;

FIG. 2 is a perspective view of the calendar roller;

FIG. 3 is a side view of a wave-forming disc;

FIG. 4 is an exploded perspective view of a wave-forming disc;

FIG. 5 is a perspective view of the shaft of the dough spreading roller with two wave-forming discs attached;

FIG. 6 is a perspective view of the dough spreading roller with a full set of wave-forming discs attached;

FIG. 7 is a side view of the assembled dough spreading roller;

FIG. 8 shows a perspective view of a calibrating mechanism for the calendar roller.

In these figures, preferred embodiments of the invention are illustrated by way of examples. It is to be expressly understood that the description and drawings are only for the purpose of illustration and are an aid for understanding. They are not intended to define the limits of the invention.

### DETAILED DESCRIPTION OF THE PREFERRED EMBODIMENTS

As used herein, any usage of terms that suggest an absolute orientation (e.g. “top”, “front”, “back” etc.) are for illustrative convenience and refer to a specific orientation. However, such terms are not to be construed in a limiting sense as it is contemplated that various components will, in practice, be utilized in orientations that are the same as, or different than those described or shown.

The invention described above provides a dough spreading roller which facilitates a gentler treatment of a dough stream. The invention is particularly useful for processing dough to be used for flatbreads.

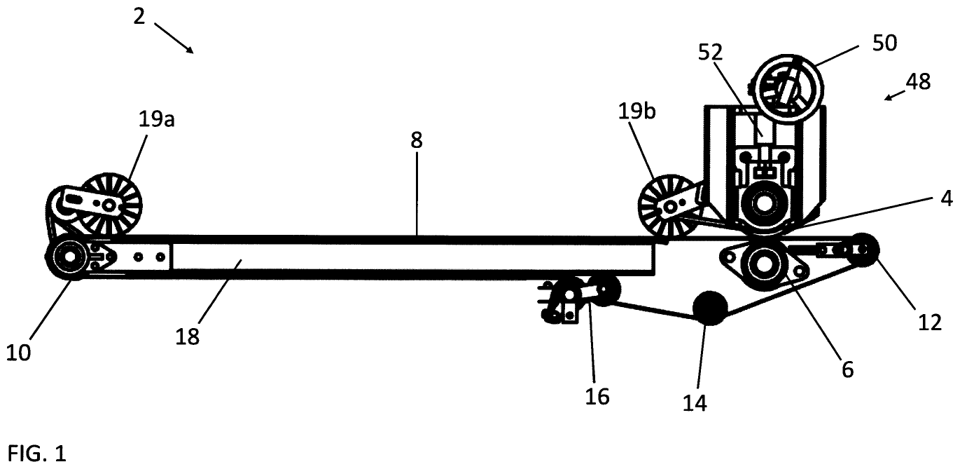

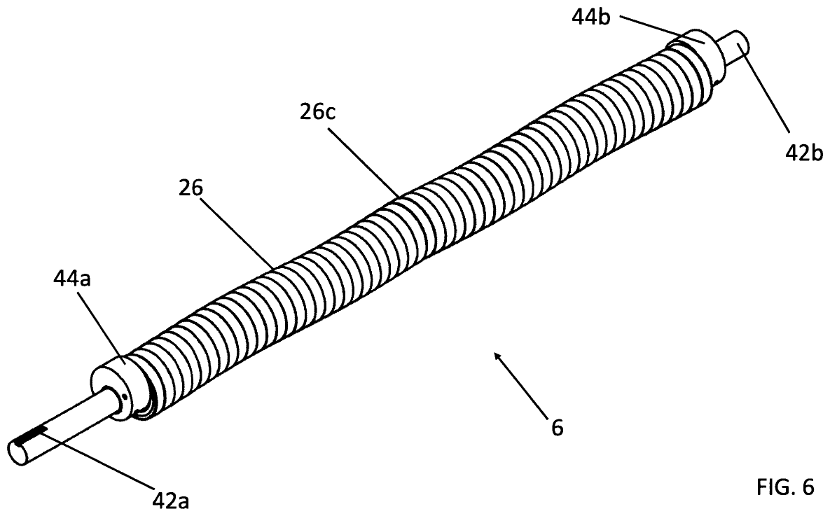

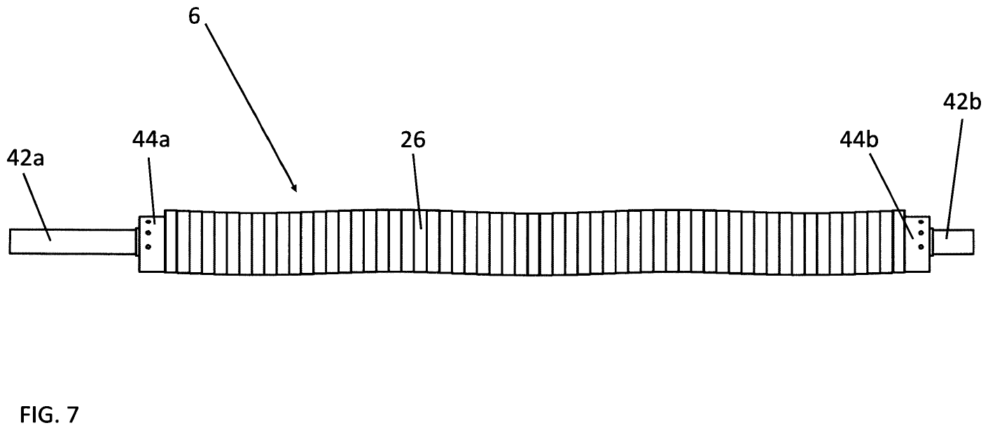

Turning now to the figures, FIG. 1 shows a side view of a dough flattening apparatus 2. A calendar roller 4 is situated above and vertically aligned with a dough spreading roller 6. As better viewed in FIGS. 6 and 7, the dough spreading roller 6 is configured to have a waveform extending along the length of the roller. The belt 8 of a conveyor system is disposed between the calendar roller 4 and the spreading roller 6. The conveyor system is configured for moving a stream of dough through the space between the calendar roller 4 and the spreading roller 6. The top of the dough spreading roller 6 is engaged with the underside of the belt 8, so that belt 8, and thus the stream of dough, is deformed by the waveform of the spreading roller 6.

It is important to configure the belt 8 to have the right amount of tension so that it is flexible enough to allow the kneading actions of the spreading roller 6 to impact the dough stream. For instance, if the belt 8 is installed tightly and is overly stretched over its frame, this may negate the effects of spreading roller 6 as it rotates underneath belt 8. In addition, it is important to choose a material for the belt 8 which is sufficiently thin and flexible to allow the undulations caused by the spreading roller 6 to come through belt 8 and have impact on the dough stream. Such suitable materials are known in the art and include thin food-grade rubbers or other polymers, or in some cases a treated cloth.

The calendar roller 4 is disposed a distance away from the belt 8 such that the distance between the outer surface of the calendar roller 4 and the belt 8 is less than the thickness of the stream of dough to be processed. The distance of the calendar roller 4 from the top surface of the belt 8 may be adjusted by a thickness adjusting mechanism 48 to select the thickness of the dough stream and the pressure to be applied by the calendar roller 4. As will be described in further detail below, an adjusting wheel 50 may be rotated to move the calendar roller along a rail 52 to the desired distance from the belt 8.

In some embodiments, the calendar roller 4 is connected to a standard motor directly, by way of a toothed gear wheel connected to a chain, or otherwise as known in the art. The calendar roller 4 rotates in the same direction as the movement of the belt 8.

The spreading roller 6 may be connected to a standard motor directly, by way of a toothed gear wheel connected to a chain, or otherwise as known in the art. The spreading roller 6 may rotate either in the direction of the movement of the belt 8 or in the opposing direction. If the spreading roller 6 has been configured to incorporate mirror image waveforms, with a central point in the middle of shaft 40 and with identical waveform patterns radiating out from the central point, in operation the spreading roller 6 will cause the stream of dough to spread progressively from the center of the belt 8 towards the outer edges of the belt 8. Speeds that have been found to work well for the spreading roller 6 are between 300 rpm and 500 rpm.

Further shown in FIG. 1 are the components of the conveyor belt and its supporting framework. A driving unit 10 is provided at one end of the belt 8. The driving unit 10 is connected to a standard motor directly, by way of a toothed gear wheel connected to a chain, or otherwise as well-known in the art. The driving unit 10 frictionally engages the inner surface of the belt 8, causing the belt 8 to move in response to the rotation of the driving unit 10. A pulley 12 is located at the opposing end of the belt 8. The pulley 12 engages the inner surface of the belt 8 and orients the movement of the belt 8, causing it to return back towards the driving unit 10.

In some embodiments, the conveyor system may further include a secondary pulley 14, disposed below the spreading roller 6, such that the belt 8 is guided away from the bottom of the spreading roller 6 in order to prevent the belt 8 from engaging the lower portion of the spreading roller 6. Preventing a second point of contact between the belt 8 and the spreading roller 6 reduces the friction applied to the components, thus reducing wear on the belt 8 and other components.

In some embodiments, the conveyor system may further include a guide roller 16, which directs the belt 8 into horizontal alignment with the bottom of the drive unit 10. This causes the inside surface of the belt 8 to be engaged with the driving unit 10 for a longer period of time, improving the transfer of motion from the driving unit 10 to the belt 8.

In some embodiments, the conveyor system may further include a belt support 18 which further guides the movement of the belt 8 and provides support to reduce deformation of the belt 8 from the weight of the dough stream.

The driving unit 10 causes the belt 8, and thus the stream of dough, to move towards the calendar roller 4 and the spreading roller 6. Speeds for the belt 8 that have been found to work well are in the range of 5-10 meters per second. The speed of the belt 8 may be adjusted to account for the type of dough, the viscosity of the dough and how much resting time is needed for the dough. As the stream of dough passes through the space between the calendar roller 4 and the spreading roller 6, the outer surface of the calendar roller 4 engages the top surface of the stream of dough thus pressing the stream of dough into the belt 8. This improves the engagement of the stream of dough with the surface of the belt 8 that is deformed by the waveform of the spreading roller 6, thus improving the transfer of the deformation from the belt 8 to the stream of dough. As the waveform moves from the center of the spreading roller 6 outward, the dough's width is increased as the dough is spread toward the edges of the belt 8 by the kneading motion of the waveform. This spreads and widens the stream of dough through an indirect motion allowing for a gentler treatment of the dough.

In some embodiments, the dough flattening apparatus may have rotating cylindrical brushes 19a, 19b connected to sources of loose flour for dusting the dough. The brushes 19a, 19b are disposed above the belt 8 and may have a width that corresponds to the width of the belt 8. The brushes 19a, 19b are made of a plurality of bristles made of nylon or another flexible food-grade bristle material. In this embodiment, the first brush 19a is configured to engage the top surface of the belt 8 to spread a dusting of flour to the dough stream as it passes through. The first brush 19a is connected to the driving unit 10 by a belt, toothed gear wheel or other method known in the art, such that the rotation of the drive unit 10 causes the rotation of the first brush 19a. The second brush 19b is configured to engage the top of the stream of dough, such that it gently spreads a dusting of flour thereon, without damaging or tearing the stream of dough. The second brush 19b is connected to the calendar roller 4 by a further belt, toothed gear wheel or other method known in the art, such that the rotation of the calendar roller 4 causes the rotation of the second brush 19b.

Not shown in FIG. 1 is the support structure holding the components of the dough flattening apparatus 2 in spatial alignment. The dough flattening apparatus 2 may be enclosed within a larger dough making machine that has a framework with receiving holes for the calendar roller 4, the spreading roller 6, and the driving unit 10, pulleys 12, 14 and guides 16 of the conveyor system.

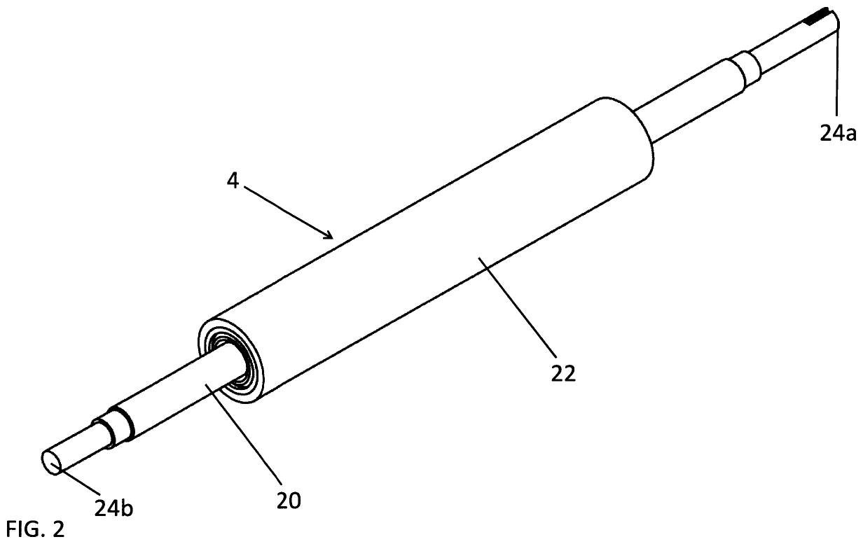

FIG. 2 shows a perspective view of a calendar roller 4 in isolation. The calendar roller 4 comprises a shaft 20 and may be made of any suitable material, such as stainless steel. The calendar roller 4 has a smooth outer surface 22 which may be covered by a food-grade rubber which will provide appropriate friction to the dough as it proceeds through the dough spreading apparatus. Calendar roller 4 is also equipped with ends 24a and 24b, which may be outfitted with known means to effectuate turning of the calendar roller 4 such as the toothed gear wheel described above.

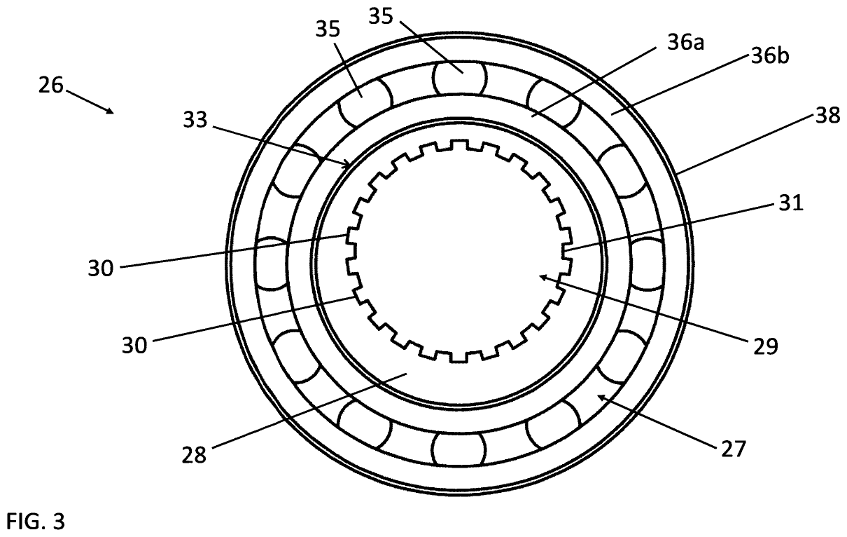

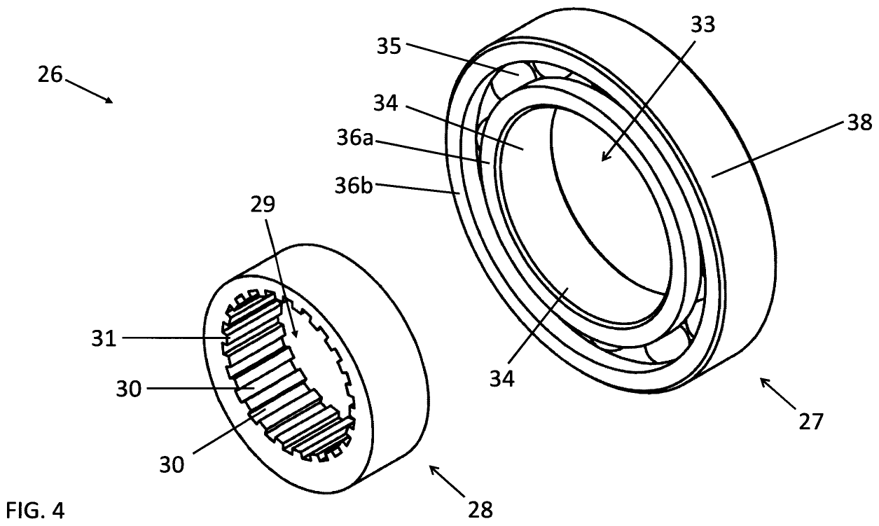

FIG. 3 shows a side view of an embodiment of a wave-forming disc 26 used to create the waveform of the spreading roller 6. The disc 26 is formed of two components: an outer bearing 27 and a core 28. These components can be better seen separately in FIG. 4.

The core 28 can be made of plastic or any suitable material and forms a shaft receiving passage 29 that receives the shaft 40 of the spreading roller 6. The position of the shaft receiving passage 29 is offset from the center of the core 28. The inner surface 31 of the core 28 forms a series of keyseats 30 which line the shaft receiving passage 29. Each keyseat 30 is configured to receive a key 46 located on shaft 40 such that engagement of the key 46 in the keyseat 30 prevents rotational motion between the shaft of the spreading roller 6 and the core 28. In the embodiment shown in FIG. 3, twenty-two keyseats 30 are formed on the inner surface 31 of core 28, with each keyseat 30 being an equal distance from each adjacent keyseat. The number of keyseats 30 and the spaces between them may be adjusted to create a customized wave form. Increasing the number of keyseats 30 and reducing the distance between adjacent keyseats 30 permits a smoother waveform to be created on the spreading roller 6, which will provide a gentler kneading motion on the dough stream. This feature permits a user to configure the spreading roller 6 to create a waveform that kneads the stream of dough as desired for the particular recipe of dough.

The outer bearing 27 features a core receiving passage 33. The core 28 fits tightly within the core receiving passage 33. In some embodiments this is accomplished via frictional engagement of the outer bearing 27 and core 28. In some other embodiments this is achieved using an adhesive between the core receiving passage 33 of the outer bearing 27 and the core 28. In some further embodiments this is accomplished by welding the core 28 to the outer bearing 27, or by outfitting both the core 28 and outer bearing with complementary threaded surfaces so that the they can be threaded together.

In the example shown in FIG. 3 the core 28 is circular. In some embodiments it may be any other shape that is complementary to the core receiving passage 33 of the outer bearing 27 and permits the shaft receiving passage 29 to be placed offset from the centre of the core 28.

In some embodiments the outer bearing 27 and the core 28 may have markings to ensure consistent alignment of core 28 when it is inserted into its respective outer bearing 27. In some other embodiments, the outer bearing 27 and the core 28 may form a key joint to ensure the consistent alignment of core 28 when it is inserted into its respective outer bearing 27.

In addition, the location of the shaft receiving passage 29 within the core 28 may be varied to be more centered or more off-centre than shown in FIG. 3. This will vary the amplitude of the waveform on the outside of the assembled roller 6, and will accordingly impact how deeply the dough stream is penetrated by the ridges of the waveform on the assembled roller 6. Depending on the particular type of dough and the recipe, some may be able to better tolerate larger amplitudes for the waveform. The particular dimensions and configurations of the wave-forming discs 26 may be set as appropriate for the product being manufactured.

When the shaft receiving passage 29 is offset as shown in FIG. 3, it will be evident that if one measures from the true centre of shaft receiving passage 29 to the closest portion of the outer surface 38 of the outer bearing 27, one will obtain the a radial measurement that may be considered a minimum radius for the wave-forming disc 26. If one measures from the centre of shaft receiving passage 29 to the furthest portion of outer surface 38, the radial measurement obtained may be considered a maximum radius. When assembled in line with adjacent wave-forming discs 26 in the manner described previously whereby their alignment each differs by the distance of one keyseat between adjacent wave-forming discs 26, the waveform created on the outer surface of the roller 6 will have a series of peaks and valleys. The amplitude of the waveform will correlate with the difference between the minimum radius and the maximum radius. The amplitude may also be conceived as correlated to the distance between the true centre of the entire wave-forming disc 26 and the centre of the shaft receiving passage 29. In either case, if a greater amplitude is desired, it will be necessary to locate the shaft receiving passage further from the centre.

In the embodiment shown in FIG. 4, the outer bearing 27 is a ball bearing. The outer bearing 27 has an inner surface defining the previously described core receiving passage 33, a plurality of balls 35, ball retaining sides 36a and 36b, and an outer surface 38. The components of the outer bearing 27 can be made of stainless steel, chrome steel, ceramic or any other appropriate material known in the art. It is preferable if the components of the outer bearing 27 are made of stainless steel or another appropriate material that resists rusting. Appropriate ball bearing parts for use as the outer bearing 27 include ball bearings corresponding to ISO designations 6011-2RS and 6011-RSR, though other forms of ball bearings may be used.

The width of core 28 is configured to be equal to or less than the width of the outer bearing 27, such that core 28 does not extend beyond the sides of the outer bearing 27 when they are engaged.

As is standard in such ball bearings, the outer surface 38 of the outer bearing 27 is rotatable with respect to the innermost ball retaining side 36a, which is in turn immovably attached to core 28. This allows the portion of the outer surface 38 in contact with the belt 8 to rotate with the movement of the belt 8 instead of scraping against the underside of belt 8, as would occur if the outer surface 38 was kept stationary relative to the rest of the disc 26. This reduces the friction between the belt 8 and the spreading roller 6, thus reducing the generation of heat and wear on the belt 8.

In some alternative embodiments the outer bearing 27 may be any form of bearing known in the art that permits the outer surface 38 of the bearing to rotate freely with respect to the rotation of the core 28 connected to the shaft of the spreading roller 6.

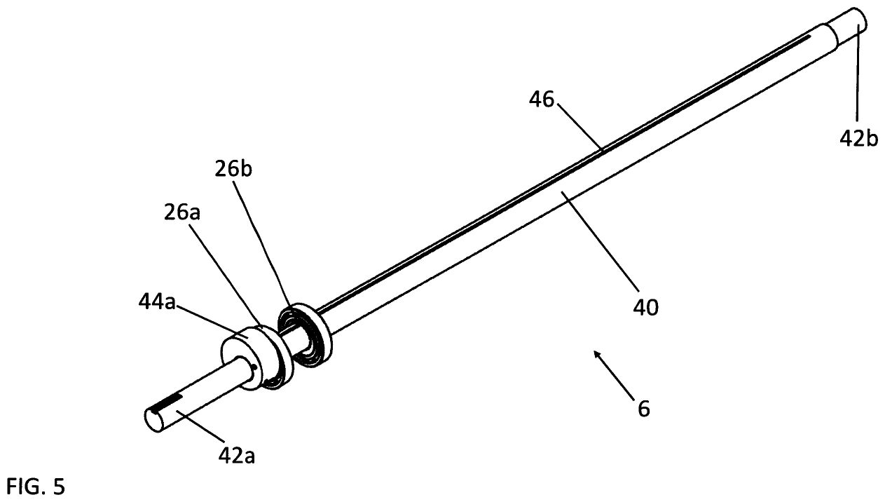

FIG. 5 shows a partially assembled spreading roller 6, with two wave-forming discs 26a and 26b attached. The spreading roller 6 comprises a shaft 40 having ends 42a and 42b. The shaft has a key 46 that engages with a keyseat 30 of each respective disc 26 to prevent relative rotation of the shaft 40 and the wave-forming discs 26. In some embodiments the key 46 may be found on the core 28 of the wave-forming disc 26 and the keyseats may be found on the shaft 40. Spreading roller 6 is also equipped with ends 42a and 42b, which may be outfitted with known means to effectuate turning of the spreading roller 6 such as the toothed gear wheel described above.

The waveform of the spreading roller 6 is formed by affixing a set of wave-forming discs 26 to the shaft 40 of the spreading roller 6. A first wave-forming disc 26a is placed on the shaft, so that the key 46 engages a keyseat 30 of the disc. This first wave-forming disc 26a forms the first discretized portion of the wave form. A second wave-forming disc 26b is rotated in a clockwise (or counter-clockwise) direction and is placed on the shaft 40, so that the key 46 engages a keyseat 30 that is adjacent to the keyseat 30 that corresponds to the keyseat 30 engaged in the first disc 26a. A third wave-forming disc (not shown) is then rotated in the same direction as the second wave-forming disc and is placed on the shaft 40, so that its key 46 engages keyseat 30 that is adjacent to the keyseat 30 that corresponds to the keyseat 30 earlier engaged in the second disc 26b. This process is performed for each wave-forming disc 26 placed on the shaft 40. Each wave-forming disc 26 must be rotated in the same direction, whether clockwise or counter clockwise, as all the previous wave-forming discs 26. As the shaft receiving passage 29 is offset from the centre of the discs 26, when adjacent discs 26 are placed on the shaft 40 so that each are offset by a single keyseat 30, they form discrete steps of the waveform to be formed by the spreading roller 6.

FIG. 5 also shows a wave-suppressing nut 44a at one end of the key 26a. Not shown in FIG. 5 is the wave-suppressing nut 44b located at the opposing end of the key 46 when a full set of wave-forming discs 26 have been connected to the shaft 40, which is better viewed in FIGS. 6 and 7. The wave-suppressing nuts 44a, 44b are also generally disc shaped and may be made as a solid piece of material with the inner surface forming a shaft receiving passage. The wave-suppressing nuts 44a, 44b may be made of stainless steel, ceramic, or other appropriate material.

In one embodiment, the inner surfaces of the wave-suppressing nuts 44a, 44b are threaded and configured to engage with a complimentary threaded portion of the shaft 40. The shaft 40 has two complimentary threaded portions located towards opposing ends the key 46. The wave-suppressing nuts 44a, 44b are securely engaged with their respective complimentary threaded portions of the shaft 40, so that wave-suppressing nuts 44a, 44b remain in place on the shaft 40 and engage the respective adjacent wave-generating discs 26 to prevent any lateral movement of wave-generating discs 26 along the shaft 40. Similarly to the configuration of the wave-generating discs 26, the shaft receiving passages of the wave-suppressing nuts 44a, 44b are also offset from their respective centers by the same or similar distance as in the wave-generating discs 26.

Other constructions are possible for the wave-suppressing nuts 44a, 44b. They may be constructed of an outer bearing and fitted core structure similar to the wave-generating discs. They may engage the shaft by known means other than through a threaded inner surface.

In the embodiment shown in FIG. 5, the wave-suppressing nuts 44a, 44b have a larger width than wave-forming discs 26a, 26b. In some embodiments the wave-suppressing nuts 44a, 44b are the same width as the wave-forming discs 26. The wave-suppressing nuts 44a, 44b are installed such that they are in opposing phase to the respective adjacent wave-forming discs 26. That is, if adjacent wave-forming disc 26a is installed as shown so that the radial measurement of the outer surface of the waveform from the shaft 40 is at its smallest at the upper surface of the spreading roller 6, then the wave-suppressing nut 44a is installed so that its corresponding smallest radial measurement is on the opposite side of the roller. In this manner, the wave-suppressing nuts 44a and 44b will hold up and support the edges of the belt 8 when the wave-generating discs such as 26a are in opposite phase.

This configuration ensures that either the wave-suppressing nuts 44a, 44b or the respective adjacent wave-forming discs 26 maintain contact with and support the edges of belt 8. By doing so, the sides of the belt 8 are kept at a more consistent height, thus reducing the vibration of the belt 8 resulting from the waveform deformation of the belt 8. This also reduces strain and wear on the belt 8 that would occur over time due to sagging and twisting.

FIG. 6 shows the spreading roller 6 with a full set of wave-forming discs 26 attached. Now shown is the full waveform created by the full set of wave-forming discs 26 placed on the shaft 40 of the spreading roller 6. FIG. 6 further shows the second wave-suppressing nut 44b which is connected to the spreading roller 6 at the end of the shaft 40 opposing the first wave-suppressing nut 44b.

In the embodiment shown in FIG. 6, a variation has been employed on the method for installing wave-forming discs 26 as described in association with FIG. 5 above. As is evident from FIG. 6, a waveform extends across the length of the shaft 40, and it can be seen that a central point for the waveform is set in the approximate middle of the shaft 40, at midpoint 26c. The wave-forming discs 26 were installed on this particular shaft 40 by first installing the wave-forming disc 26 which would occupy midpoint 26c, and then turning the adjacent wave-forming discs 26 on either side of 26c by one keyseat width as described previously. Both adjacent wave-forming discs 26 on either side of the midpoint 26c are turned in the same direction as each other, whether clockwise or counter clockwise. The same pattern is repeated for the next adjacent wave-forming discs 26. In this manner, mirror image waveform patterns radiate outwards from midpoint 26c. This waveform pattern and configuration for spreading roller 6, when employed in apparatus 2 to spread and flatten a dough stream, results in said dough stream being equally spread in directions outwards from its centre.

FIG. 7 is a further side view of the spreading roller 6 with a full set of wave-forming discs 26 attached. More clearly shown in FIG. 7 is the waveform created on the shaft 40 when the full set of wave-forming discs 26 are attached. In the embodiment shown, as described previously, the waveform moves from the center 26c of the spreading roller 6 outward, each half mirroring the shape of the other side. However, embodiments are possible in which each half of the waveform does not mirror the shape of the other side. Also shown more clearly in FIG. 7 are the wave-suppressing nuts 44a, 44b being attached to the shaft 40 in opposing phase to the respective adjacent wave-forming discs 26. In the embodiment shown in FIG. 7 each half of the waveform mirrors the other and as such, the wave-suppressing nuts 44a, 44b are attached to the shaft in the same orientation. In some embodiments where each half of the waveform does not mirror the other, the wave-suppressing nuts 44a, 44b may not be attached to the shaft in the same orientation.

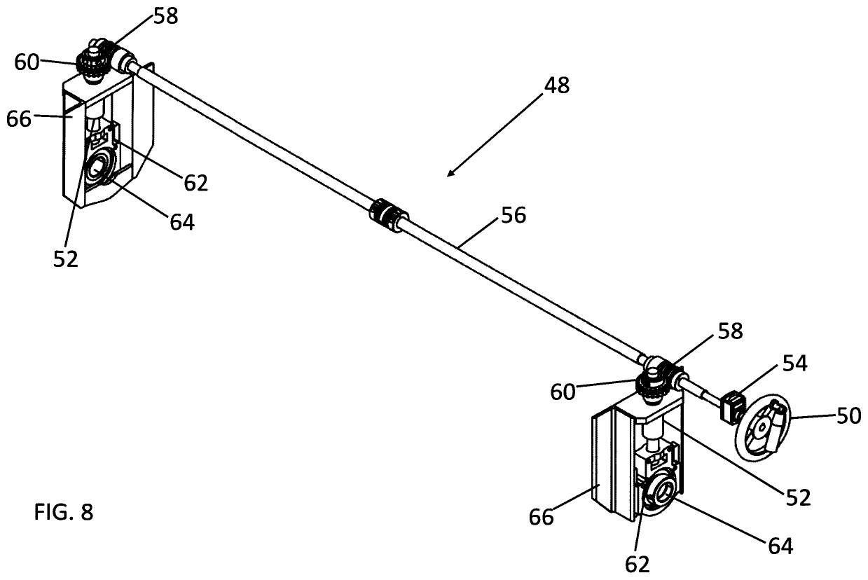

In FIG. 8, a perspective view of the thickness adjusting mechanism 48 is shown. The manual adjusting wheel 50 may be connected to a graduated counter 54 on the shaft 56 so that the user may conveniently set the thickness of the resulting dough stream that is the most appropriate target thickness for the product being made. Worm screws 58 are connected to the shaft 56 and are engaged with worm gears 60 connected to rails 52. The rails 52 are connected to calendar roller support structures 62 configured to support the weight of movable calendar roller 4 and allow the free rotation of calendar roller 4. The calendar roller support structures 62 comprise a calendar roller receiving hole 64 for engaging the ends 24a, 24b of the calendar roller 4. The calendar roller support structures 62 are disposed within respective support structure housings 66 which act as a guide for the calendar roller support structure 62 as they are moved along their respective rails.

Component parts for a roller 6 may also be provided as a kit for assembly by the user who possesses a suitable industrial bread making apparatus. The kit may include a shaft 40 with appropriate configurations at its ends 42a and 42b, as well as the appropriate number of wave-forming discs 26 and a pair of wave-suppressing nuts 44 that the user can install on shaft 40 in accordance with instructions also provided. It is also possible that the user who already possesses a suitable shaft 40 and set of outer bearings 27 may only require a kit with cores 27 configured to have the suitable amount of offset for their respective shaft receiving passage 29, as well as matching wave suppressing nuts 44.

By providing such kits, the operator of an industrial facility for manufacturing breads, if using the same machine for different batches and recipes, may remove the roller 6 and change out the wave-forming discs 26 if a different level of processing of the dough is required for the batch to be made. With the acquisition of additional kits having wave-forming discs 26 or simply the cores 27 in different sizes, the user may enjoy more versatility with the same industrial bread making apparatus, which can be readily adapted depending on the batch of product being made.

The invention described above provides a dough spreading and flattening apparatus for use in the industrial manufacture of breads, and is particularly well-adapted for the manufacture of flatbreads made from doughs which are more sensitive to the effects of over processing. The invention as described herein includes a dough stream spreading means as well as calibration means with a customizable spreading roller that can be configured to use a variety of waveforms to widen a dough stream. This configuration allows for a gentler treatment of the dough and ultimately results in dough that, because it is soft and not over-worked or over-stressed, can be more readily and uniformly shaped, and baked to have the desired textural features for the type of flatbread being prepared.

While the invention has been described with reference to specific embodiments, it will be appreciated that numerous variations, modifications, and embodiments are possible. For instance, there are many known mechanisms available in machinery design that may be used interchangeably with the specific mechanical solutions contemplated above. Accordingly, all variations, modifications and embodiments are to be regarded as being within the spirit and scope of the invention.

1. A roller, comprising
a shaft having two ends and a circumference;
a plurality of circular discs each having a disc outer surface, and a disc centre point equidistant from all portions of said disc outer surface;
said discs each incorporating a generally circular disc passage that accommodates the circumference of said shaft, said passage having a passage centre point, the location of said passage centre point being different from said disc centre point by a distance defined as the offset amount;
said discs having a maximum disc radius defined as a maximum distance measured from said passage centre point to said disc outer surface;
a plurality of circular nuts each incorporating a nut outer surface and a generally circular nut passage that accommodates the circumference of said shaft;
a maximum nut radius defined as a maximum distance measured from said nut passage centre point to said nut outer surface;
said plurality of circular discs and said plurality of nuts being installed on said shaft.

2. The roller of claim 1, wherein two of said nuts are each installed closer to said ends of said shaft than any of said discs.

3. The roller of claim 1, wherein said shaft further comprises a ridge, and said disc passages incorporate a plurality of indentations around said passages, each of said indentations sized to fit said ridge.

4. The roller of claim 1, wherein said discs are installed on said shaft such that said disc outer surfaces combine to form an undulating surface.

5. The roller of claim 1, wherein said nut passage is off-centre within said nut by a distance equal to or greater than said offset amount for said discs.

6. The roller of claim 2, wherein said nuts are each installed adjacent to one of said discs, such that said maximum disc radius of said adjacent disc and said maximum nut radius of the nut are aligned by about 180° with respect to each other.

7. The roller of claim 2, each nut having a threaded inner surface and each shaft end having a complimentary threaded surface to engage said nut.

8. The roller of claim 4, wherein there is a midpoint between said ends of said shaft dividing said undulating surface into two sections, the two sections forming mirror images of each other around the midpoint.

9. An apparatus for flattening dough, comprising the roller of claim 1, a calendar roller, a conveyor belt having a top side and an underside, and drive units for turning said rollers and said conveyor belt, wherein said roller is installed at said underside, and said calendar roller is installed at said top side, such that said roller and said calendar roller oppose each other.

10. The apparatus of claim 9, wherein said calendar roller is provided with a means of adjusting its distance from said top side.

11. The apparatus of claim 9, further provided with pulleys to route said conveyor around said roller so that said conveyor only contacts said roller at said top side opposite from said calendar roller.

12. A method of flattening a stream of dough using the apparatus of claim 9, consisting of:
providing a stream of dough to a receiving end of the conveyor belt;
transporting said stream of dough along said conveyor belt and between said roller and said calendar roller;
rotating said roller and said calendar roller such that said calendar roller applies a force on the stream of dough and the roller provides an opposing force on the stream of dough through said conveyor belt, thus flattening the stream of dough.

13. A kit for assembling a dough spreading roller comprising:
a plurality of cores, each core comprising an outer surface and a core inner surface defining a shaft receiving passage, the shaft receiving passage offset from the centre of the core and configured to engage with the shaft such that there is no relative rotation between the core and the shaft;
a plurality of bearings, each bearing comprising a bearing inner surface that defines a core receiving passage, the core receiving passage configured to receive a core and engage the outer surface of the core such that there is no relative rotation between the core and the inner surface of the bearing.
a plurality of nuts, each nut having a shaft receiving passage and configured to engage with said shaft.

14. A kit for adapting a dough spreading roller of claim 1, comprising a plurality of cores, each core comprising an outer surface and an inner surface defining a shaft receiving passage, the shaft receiving passage offset from the centre of the core and configured to engage with the shaft such that there is no relative rotation between the core and the shaft; and a plurality of nuts, each nut having a shaft receiving passage and configured to engage with said shaft.
